(19) United States
(12) Patent Application Publication
(10) Pub. No.: US 2013/0038772 A1
(43) Pub. Date: Feb. 14, 2013

(54) IMAGE PROCESSING APPARATUS AND IMAGE PROCESSING METHOD

(71) Applicant: PEI-CHONG TANG, Tu-Cheng (TW)

(72) Inventor: PEI-CHONG TANG, Tu-Cheng (TW)

(73) Assignee: HON HAI PRECISION INDUSTRY CO., LTD., Tu-Cheng (TW)

(21) Appl. No.: 13/555,079

(22) Filed: Jul. 20, 2012

(30) Foreign Application Priority Data
Aug. 9, 2011 (CN) 201110226955.5

(51) Int. Cl. H04N 9/07; H04N 5/225

(52) U.S. Cl. 348/336; 348/207.99; 348/E09.003; 348/E05.024

(57) ABSTRACT

An image processing method includes the steps of: receiving the plurality of single color image signals from an image sensor, and delaying the received single color image signals belonging to a plurality of pixels for storing in a delay unit; retrieving the single color image signals from the delay unit simultaneously, and determining original R, G, and B values for each of the two neighboring pixels of the image sensor with respect to the retrieved single color image signals using an interpolation algorithm; converting the original R, G, and B values for each of the two neighboring pixels to Y, U, and V values; calculating an average Y value of two Y values for two neighboring pixels in the two neighboring pixels; converting the calculated Y value, the U value, and the V value to new R, G, and B values.

### BACKGROUND

1. Technical Field

The disclosed embodiments relate to an image processing method and an image processing apparatus including an image processing circuit.

2. Description of Related Art

Image sensors such as charge coupled device (CCD) image sensors and complementary metal oxide semiconductor (CMOS) image sensors are widely used in image processing apparatuses (e.g., digital cameras, camcorders, and scanners). Typically, an image sensor includes a plurality of photo-sensors (also referred as pixels) arranged in multiple rows and multiple columns. The photo-sensors can convert optical image to electrical signals for constructing an image. However, the photo-sensors by themselves are not able to detect optical image with a wavelength range. In other words, the photo-sensors cannot separate color information.

Therefore, a color filter array (CFA) may be employed in an image sensor to obtain color information. One typical pattern of the CFA is 50% green, 25% red, and 25% blue, hence is also called GRGB or other permutation such as RGGB, so as to simulate the human eye's greater resolving power with green light. This typical pattern is also called Bayer pattern, in honor of the person who has invented the pattern. The CFA is able to filter optical image by wavelength range, such that filtered light includes color information about the optical image.

Because each pixel is filtered to record only one of three colors, two-thirds of the color data is missing from each pixel. In order to obtain a full-color image, various interpolation algorithms have been used to determine a set of complete red, green, and blue values for each pixel. Different interpolation algorithms requiring various amounts of computing power result in varying quality of captured images.

Referring to FIG. 7, a typical interpolation algorithm uses four neighboring pixels to determine a set of complete red (R), green (G), and blue (B) values for each pixel. Supposing that an original image includes a left area and a right area, the left area includes pixels B11, G12, B13, G21, R22, and G23, and the R, G, B values of the left area respectively equal to 0, 255, and 0 (R=0, G=255, B=0). The right area includes pixels G14, B15, G16, R24, G25, and R26, and the R, G, B values of the right area respectively equal to 100, 0, and 255 (R=100, G=0, B=255). The image sensor captures the above original image, and calculates a set of complete red, green, and blue values for each pixel using the above typical interpolation algorithm, taking pixel B13 as an example, the R, G, B values of pixel B13 are calculated according to the following three equations:

B13−R=G14−R=R24=100;

B13−G=G14−G=(G14+G23)/2=128;

B13−B=G14−B=B13=0.

In the original image, the R, G, B values of pixel B13 (B13−R=0, B13−G=255, B13−B=0) are not the same as the R, G, B values of pixel G14 (G14−R=100, G14−G=128, G14−B=0). However, in the captured image, the R, G, B values of pixel B13 (B13−R=100, B13−G=128, B13−B=0) are the same as the R, G, B values of pixel G14 (G14−R=100, G14−G=128, G14−B=0), it is obvious that the quality of the captured image is reduced.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the seven views.

FIG. 1 is a block diagram showing an image processing apparatus employing an image processing circuit in accordance with an embodiment, the image processing circuit includes a process unit.

FIG. 2 is one embodiment of a pattern of the color filter array of the image sensor.

FIG. 3 is a block showing one embodiment of eight neighboring pixels to determine two set of complete R, G, B value of two pixels in FIG. 2.

FIG. 4 shows different sets of equations to calculate separate color values of a particular pixel according to an interpolation algorithm.

FIG. 5 is a detailed circuit diagram of one embodiment of the process unit in FIG. 1.

FIG. 6 illustrates one embodiment of an image processing method for determining a set of complete color information of a particular pixel.

FIG. 7 shows one embodiment of an interpolation algorithm utilizing four neighboring pixels to determine a set of complete R, G, B value of a particular pixel in a related art.

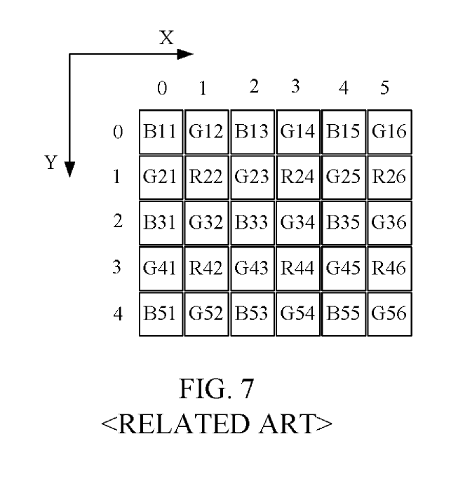

### DETAILED DESCRIPTION

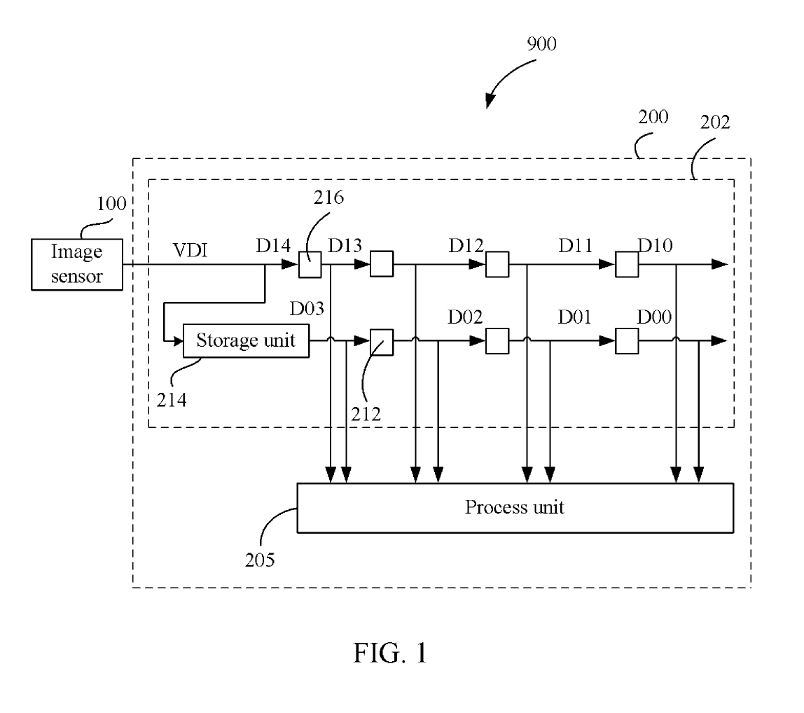

Referring to FIG. 1, an image processing apparatus 900 in accordance with an embodiment includes an image sensor 100 and an image processing circuit 200 electrically connected to the image sensor 100. The image sensor 100 is configured for capturing incident light from an object, and converting the incident light into image signals. The image processing circuit 200 is configured for processing the image signals from the image sensor 100 to produce a full-color image.

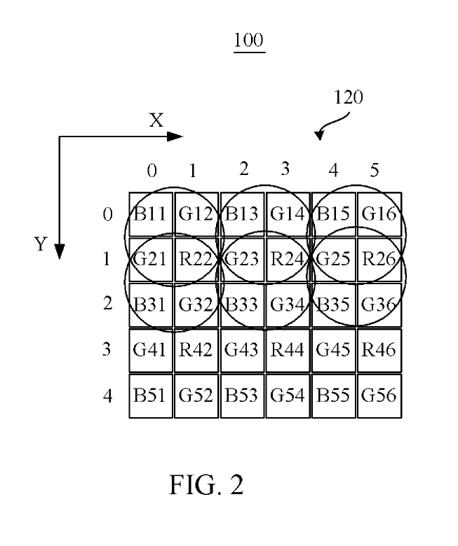

FIG. 2, illustrates the image sensor 100 according to the embodiment. The image sensor 100 includes a plurality of photo-sensors arranged in an array with multiple rows indicated as Y and multiple columns indicated as X, and a color filter array (CFA) 120. The plurality of photo-sensors are also referred to as pixels and may be defined by a coordinate system, such as pixel Y[0]X[0], for example. The CFA 120 may be a Bayer pattern including a plurality of tiny color filters, which may be positioned over the plurality of photo-sensors correspondingly. The tiny color filters are configured for filtering the incident light originated from or reflected by the object by wavelength range. The filtered optical image is converted into image signals by the photo-sensors correspondingly.

As each photo-sensor is arranged with one corresponding tiny color filter, the image signals for each pixel only contain a single color information. Therefore, the image signals outputted from the image sensor 100 can also be referred as single color image signals.

The image processing circuit 200 in accordance with one exemplary embodiment includes a delay unit 202 and a process unit 205. The delay unit 202 includes a plurality of first registers 212, a storage unit 214, and a plurality of second registers 216. The storage unit 214 may be random access memories (RAMs).

The storage unit 214 is connected to an output terminal of the image sensor 100. The storage unit 214 is configured for storing image signals of all pixels of the image sensor 100 arranged in a first row. For example, when the image sensor 100 has a resolution of 1024*768 (1024 columns and 768 rows), the storage unit 214 can store the image signals generated by pixels of the image sensor 100 arranged in the first row Y[0].

The first registers 212 are connected in series with an output terminal of the storage unit 214, and the first registers 212 are configured for delaying the image signals directly outputted from the storage unit 214. The second registers 216 are connected in series with the output terminal of the image sensor 100, and the second registers 216 are configured for delaying the image signals directly outputted from the image sensor 100 arranged in a second row adjacent to the first row. Each of the first registers 212 stores the single color image signal belonging to one pixel arranged in the first row, and each of the second registers 216 stores the single color image signal belonging to one pixel arranged in the second row.

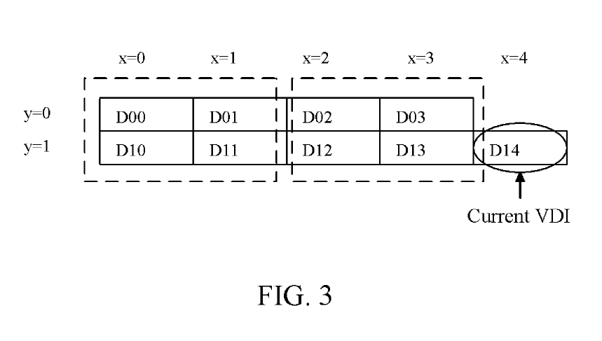

Referring also to FIG. 3, for example, four of the second registers 216 delays image signals directly outputted from the image sensor 100. When the image signals generated by a pixel Y[2]X[4] is D14, the image signals D10-D13 stored in the four of the second registers 216 (hereinafter, “the four second registers”) belong to four pixels Y[1]X[0]-Y[1]X[3] arranged in row Y[1]. Three of the first registers 212 (hereinafter, “three first registers”) are used for storing image signals D00-D02 belonging to two pixels Y[0]X[0]-Y[0]X[2] arranged in row Y[0].

The process unit 205 has multiple input terminals connected to the four second registers 216, the three first registers 212, and the output terminal of the storage unit 214. The process unit 205 is configured for reading the image signals stored in the four second registers 216, the three first registers 212, and the storage unit 214. When the first registers 212 are stored with the image signals D00-D02, the process unit 205 will be triggered by a clock signal to read the image signals stored in the first registers 212, the second registers 214, and the storage unit 214 relating to eight neighboring pixels X[0]Y[0]-X[3]Y[0], and X[0]Y[1]-X[3]Y[1].

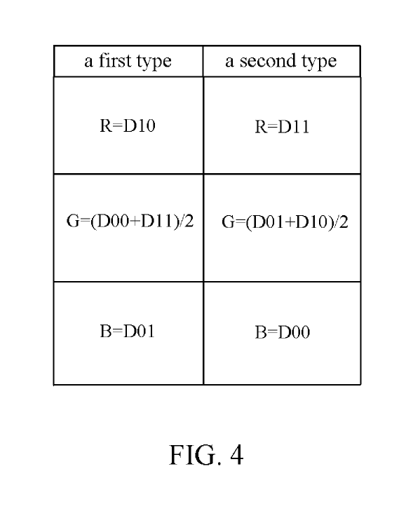

After the image signals of the eight neighboring pixels are obtained, the process unit 205 determines a set of complete red, green, and blue values of a particular pixel using an interpolation algorithm as will be further described below. Because four neighboring pixels of a Beyer pattern can be arranged in two ways, there are two set of equations which can be utilized to calculate the complete color information of the particular pixel. Referring also to FIG. 4, two sets of equations are illustrated to calculate the complete color information of the particular pixel.

For example, in a first type, three equations EQ 1-EQ 3 are utilized for calculating the set of complete red, green, and blue values of the pixel X[1]Y[0] are set forth below, three equations EQ 4-EQ 6 are utilized for calculating the set of complete red, green, and blue values of the pixel X[3]Y[0] are set forth below. In this embodiment, the set of complete red, green, and blue values of the pixel X[0]Y[0] is the same as the set of complete red, green, and blue values of the pixel X[1]Y[0]. The set of complete red, green, and blue values of the pixel X[2]Y[0] is the same as the set of complete red, green, and blue values of the pixel X[3]Y[0].

X[1]Y[0]−R=X[0]Y[0]−R=D10 (EQ 1)

X[1]Y[0]−G=X[0]Y[0]−G=(D00+D11)/2 (EQ 2)

X[1]Y[0]−B=X[0]Y[0]−B=D01 (EQ 3)

X[3]Y[0]−R=X[2]Y[0]−R=D12 (EQ 4)

X[3]Y[0]−G=X[2]Y[0]−G=(D02+D13)/2 (EQ 5)

X[3]Y[0]−B=X[2]Y[0]−B=D03 (EQ 6)

In a second type, three equations EQ 7-EQ 9 are utilized for calculating the set of complete red, green, and blue values of the pixel X[1]Y[0] are set forth below, three equations EQ 10-EQ 12 are utilized for calculating the set of complete red, green, and blue values of the pixel X[2]Y[0] are set forth below. In this embodiment, the set of complete red, green, and blue values of the pixel X[0]Y[0] is the same as the set of complete red, green, and blue values of the pixel X[1]Y[0]. The set of complete red, green, and blue values of the pixel X[3]Y[0] is the same as the set of complete red, green, and blue values of the pixel X[2]Y[0].

X[1]Y[0]−R=X[0]Y[0]−R=D11 (EQ 7)

X[1]Y[0]−G=X[0]Y[0]−G=(D01+D10)/2 (EQ 8)

X[1]Y[0]−B=X[0]Y[0]−B=D00 (EQ 9)

X[2]Y[0]−R=X[3]Y[0]−R=D13 (EQ 10)

X[2]Y[0]−G=X[3]Y[0]−G=(D03+D12)/2 (EQ 11)

X[2]Y[0]−B=X[3]Y[0]−B=D02 (EQ 12)

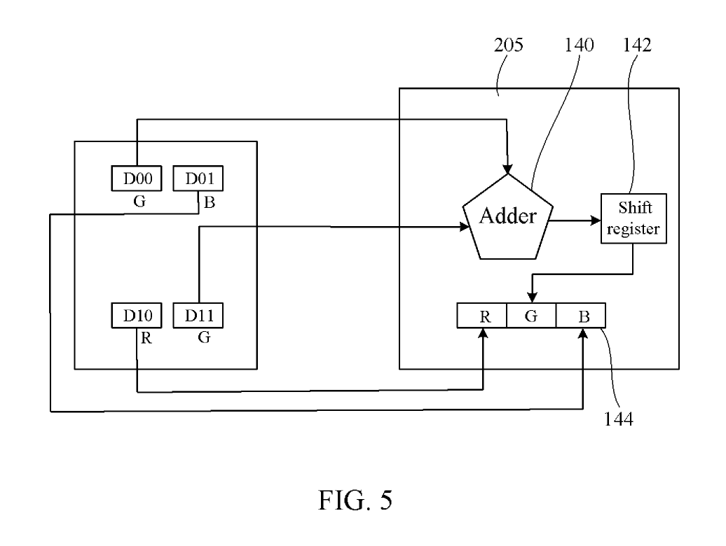

FIG. 5, illustrates a detailed diagram of one embodiment of the process unit 205. The process unit 205 determines a set of complete red, green, and blue values of a particular pixel. The process unit 205 includes an adder 140, a shift register 142, and a storage unit 144. The adder 140 is configured for receiving the image signals generated from each pixel of the image sensor 10, and performing an add operation with the received image signals to generate sum data according to the above mentioned equations.

The shifter register 364 is electrically connected to the adder 140. The shift register 142 is configured for receiving sum data from the adder 140, and performing a divide operation to the sum data. More specifically, when the sum data received from the adder 140 is divided by two, the shift register 142 moves the binary data stored to the right by one bit.

The storage unit 144 is electrically connected to the shift register 142. The storage unit 144 is divided into three blocks, which are configured for storing a set of complete red, green, and blue values of a particular pixel respectively.

The process unit 205 is further configured for converting the red, green, and blue values of the pixel X[1]Y[0] to luminance (Y), chrominance (U), and chroma (V) values; and converting the red, green, and blue values of the pixel X[2]Y[0] to luminance (Y), chrominance (U), and chroma (V) values. A first formula is utilized for performing the above conversion, the first formula is shown below:

Y=0.299R+0.587G+0.114B;

U=−0.147R−0.289G+0.436B;

V=0.615R−0.515G−0.100B.

The process unit 205 further calculates an average Y value of two Y values for two neighboring pixels X[1]Y[0] and X[2]Y[0]; and keeping the U values and the V values unchanged for the two neighboring pixels X[1]Y[0] and X[2]Y[0].

The process unit 205 further converts the calculated Y value, the U value, and the V value to new R, G, and B values. A second formula is utilized for converting the calculated Y value, the U value, and the V value to the new R, G, and B values, the second formula is shown below:

R=Y+1.14V;

G=Y−0.39U−0.58V;

B=Y+2.03U.

Referring back to FIG. 2, a typical interpolation algorithm uses four neighboring pixels to determine a set of complete red (R), green (G), and blue (B) values for each pixel. An original image includes a left area and a right area, the left area includes pixels B11, G12, B13, G21, R22, and G23, and the R, G, B values of the left area respectively equal to 0, 255, and 0 (R=0, G=255, B=0). The right area includes pixels G14, B15, G16, R24, G25, and R26, and the R, G, B values of the right area respectively equal to 100, 0, and 255 (R=100, G=0, B=255). The image sensor captures the above original image, and calculates a set of complete red, green, and blue values for each pixel using the above typical interpolation algorithm, the image processing method includes the following steps.

Step 1: calculating original R, G, B values for the B11, G12, B13, G14, B15, G16, G21, R22, G23, R24, G25, and R26 pixels;

B11−R=G12−R=R22=0

B11−G=G12−G=(G12+G21)/2=(255+255)/2=255

B11−B=G12−B=B11=0

B13−R=G14−R=R24=100

B13−G=G14−G=(G23+G14)/2=(255+0)/2=128

B13−B=G14−B=B13=0

B15−R=G16−R=R26=100

B15−G=G16−G=(G16+G25)/2=(0+0)/2=0

B15−B=G16−B=B15=255

G21−R=R22−R=R22=0

G21−G=R22−G=(G21+G32)/2=(255+255)/2=255

G21−B=R22−B=B31=0

G23−R=R24−R=R24=100

G23−G=R24−G=(G23+G34)/2=(255+0)/2=128

G23−B=R24−B=B33=0

G25−R=R26−R=R26=100

G25−G=R26−G=(G25+G36)/2=(0+0)/2=0

G25−B=R26−B=B35=255

Step 2: converting the above original R, G, and B values to Y, U, V values.

### B11−RGB(0, 255, 0)--->B11−YUV(150, −74, −131)

### G12−RGB(0, 255, 0)--->G12−YUV(150, −74, −131)

### B13−RGB(100, 128, 0)--->B13−YUV(105, −52, −4)

### G14−RGB(100, 128, 0)--->G14−YUV(105, −52, −4)

### B15−RGB(100, 0, 255)--->B15−YUV(59, 96, 36)

### G16−RGB(100, 0, 255)--->G16−YUV(59, 96, 36)

### G21−RGB(0, 255, 0)--->G21−YUV(150, −74, −131)

### R22−RGB(0, 255, 0)--->R22−YUV(150, −74, −131)

### G23−RGB(100, 128, 0)--->G23−YUV(105, −52, −4)

### R24−RGB(100, 128, 0)--->R24−YUV(105, −52, −4)

### G25−RGB(100, 0, 255)--->G25−YUV(59, 96, 36)

### R26−RGB(100, 0, 255)--->R26−YUV(59, 96, 36)

Step 3: sampling the above Y, U, V values for B11, G12, B13, G14 pixels according to YUV422 format; wherein the final Y value is calculated by the average two Y values for two neighboring pixels, and the final U value and final V value stays unchanged;

$$\begin{matrix} & B 11 & & & G 12 & & & B 13 & & & G 14 & \\ Y & U & V & Y & U & V & Y & U & V & Y & U & V \\ 150 & - 74 & - 131 & 150 & - 74 & - 131 & 105 & - 52 & - 4 & 105 & - 52 & - 4 \\ Y & U & Y & V & Y & U & Y & V & Y & U & & \\ 150 & - 74 & 150 & - 131 & 105 & - 52 & 105 & - 4 & 59 & 96 & & \\ Y & U & Y & V & Y & U & Y & V & & & & \\ 150 & - 74 & 128 & - 131 & 105 & - 52 & 82 & - 4 & & & & \\ Y & U & V & U & Y & V & Y & U & V & U & Y & V \\ 150 & - 74 & - 131 & - 74 & 128 & - 131 & 105 & - 52 & - 4 & - 52 & 82 & - 4\end{matrix}$$

Step 4: converting the final Y, U, and V value to new R, G, and B values.

$$\begin{matrix} & B 11 & & & G 12 & & & B 13 & & & G 14 & \\ Y & U & V & U & Y & V & Y & U & V & U & Y & V \\ 150 & - 74 & - 131 & - 74 & 128 & - 131 & 105 & - 52 & - 4 & - 52 & 82 & - 4 \\ R & G & B & R & G & B & R & G & B & R & G & B \\ 0 & 255 & 0 & - 21 & 233 & 0 & 100 & 128 & 0 & 77 & 105 & - 24\end{matrix}$$

In the related art, in the captured image, the R, G, B values of pixel B13 (B13−R=100, B13−G=128, B13−B=0) are the same as the R, G, B values of pixel G14 (G14−R=100, G14−G=128, G14−B=0). In the present disclosure seen above, the R, G, B values of pixel B13 (B13−R=100, B13−G=128, B13−B=0) are not the same as the R, G, B values of pixel G14 (G14−R=77, G14−G=105, G14−B=−24), compared to the related art, the quality of the captured image in the present disclosure is enhanced.

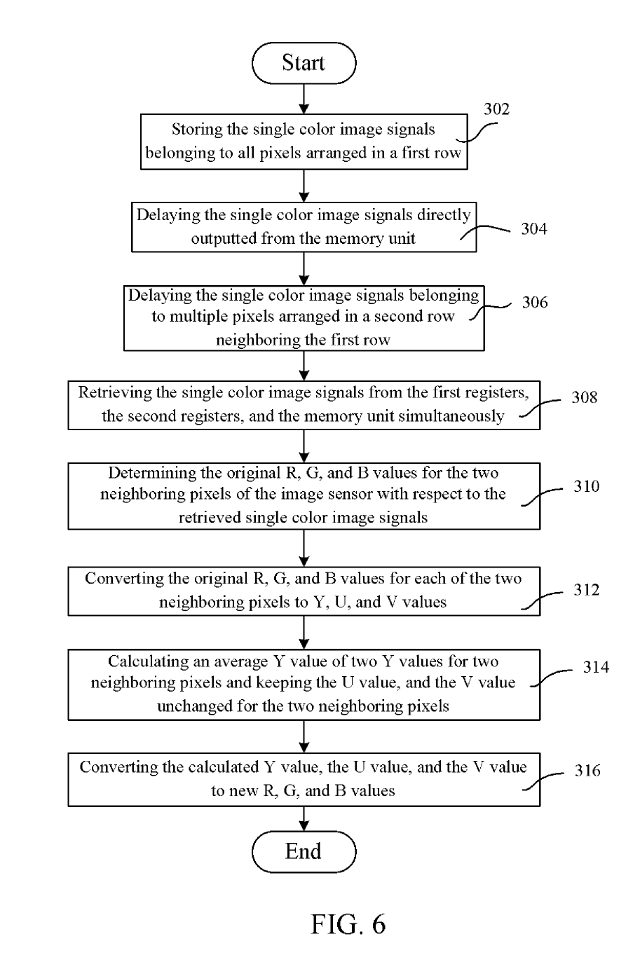

Referring to FIG. 6, an image processing method 300 is illustrated. The image processing apparatus 900 implements the image processing method 300. The image processing method 300 includes the following steps:

Step 302: the storage unit 214 stores the single color image signals belonging to all pixels arranged in a first row;

Step 304: the first registers 212 delays the single color image signals directly outputted from the storage unit 214;

Step 306: the second registers 216 delays the single color image signals belonging to multiple pixels arranged in a second row neighboring the first row.

Step 308: the process unit 205 retrieves the single color image signals from the first registers 212, the second registers 216, and the storage unit 214 simultaneously. In other embodiments, the first registers 212 are electrically connected in series with the output terminal of the image sensor 100 for delaying the single color image signals belonging to multiple pixels arranged in a first row. The second registers 214 are electrically connected in series with the output terminal of the image sensor 100 for Page 10 of 17 delaying the single color image signals belonging to multiple pixels arranged in a second row neighboring the first row; the process unit 205 retrieves the single color image signals from the first registers 212 and the second registers 214 simultaneously.

Step 310: the process unit 205 determines the original R, G, and B values for the two neighboring pixels of the image sensor with respect to the retrieved single color image signals using an interpolation algorithm.

Step 312: the process unit 205 converts the original R, G, and B values for each of the two neighboring pixels to luminance (Y), chrominance (U), and chroma (V) values. A first formula is utilized for performing the above conversion, the first formula is shown below:

Y=0.299R+0.587G+0.114B;

U=−0.147R−0.289G+0.436B;

V=0.615R−0.515G−0.100B.

Step 314: the process unit 205 calculates an average Y value of two Y values for two neighboring pixels and keeps the U value, and the V value unchanged for the two neighboring pixels.

Step 316: the process unit 205 converts the calculated Y value, the U value, and the V value to new R, G, and B values. A second formula is utilized for converting the calculated Y value, the U value, and the V value to the new R, G, and B values, the second formula is shown below:

R=Y+1.14V;

G=Y−0.39U−0.58V;

B=Y+2.03U.

Alternative embodiments will become apparent to those skilled in the art without departing from the spirit and scope of what is claimed. Accordingly, the present disclosure should not be deemed to be limited to the above detailed description, but rather only by the claims that follow and the equivalents thereof.

What is claimed is:

1. An image processing apparatus, comprising:
an image sensor for outputting a plurality of single color image signals; and
an image processing circuit coupled to the image sensor, the image processing circuit comprising:
a delay unit for receiving the single color image signals, and delaying the received single color image signals belonging to a plurality of pixels for storing in the delay unit;
a process unit coupled to the delay unit; and
one or more programs; wherein the one or more programs are configured to be executed by the process unit, the one or more programs comprises:
instructions for retrieving the single color image signals from the delay unit simultaneously, and determining original red (R), green (G), and blue (B) values for two neighboring pixels of the image sensor with respect to the retrieved single color image signals using an interpolation algorithm;
instructions for converting the original R, G, and B values for each of the two neighboring pixels to luminance (Y), chrominance (U), and chroma (V) values;
instructions for calculating an average Y value of two Y values for the two neighboring pixels, and keeping the U value and the V value unchanged for each of the two neighboring pixels; and
instructions for converting the calculated Y value, the U value, and the V value to new R, G, and B values.

2. The image processing apparatus of claim 1, wherein the image sensor comprises a plurality of photo sensors arranged in an array having multiple rows and multiple columns, and a color filter array comprising a plurality of color filters respectively positioned over the photo sensors; each color filter is configured for filtering optical image originating from an object to generate the single color optical image, each photo sensor is configured for converting the single color optical image to generate the single color image signal.

3. The image processing apparatus of claim 2, wherein the delay unit comprises a plurality of first registers, a plurality of second registers, and a storage unit; the storage unit is configured for storing the single color image signals belonging to all pixels arranged in a first row; the storage unit comprises a first terminal electrically connected to an output terminal of the image sensor, and a second terminal electrically connected to the first registers in series; the first registers are configured for delaying the single color image signals directly outputted from the storage unit; the second registers are electrically connected in series with an output terminal of the image sensor for directly delaying the single color image signals belonging to multiple pixels arranged in a second row adjacent to the first row.

4. The image processing apparatus of claim 3, wherein each of the first registers stores the single color image signal belonging to one pixel arranged in the first row, and each of the second registers stores the single color image signal belonging to one pixel arranged in the second row.

5. The image processing apparatus of claim 3, wherein the process unit retrieves the single color image signals from the first registers, the second registers, and the storage unit simultaneously.

6. The image processing apparatus of claim 5, wherein the process unit further determines the original R, G, and B values for the two neighboring pixels of the image sensor with respect to the retrieved single color image signals belonging to eight neighboring pixels using an interpolation algorithm.

7. The image processing apparatus of claim 5, wherein the process unit further comprises:
an adder configured for performing an add operation with respect to the same single color image signals retrieved from the first registers, the second registers, and the storage unit simultaneously; and generating a sum data; and
a shift registers electrically coupled to the adder for performing a divide operation with respect to the sum data to determine the original R, G, and B values for each of the two neighboring pixels of the image sensor.

8. The image processing apparatus of claim 1, wherein a first formula is utilized for converting the original R, G, and B values to the Y, U, and V values, the first formula is shown below:
Y=0.299R+0.587G+0.114B;
U=−0.147R−0.289G+0.436B;
V=0.615R−0.515G−0.100B.

9. The image processing apparatus of claim 1, wherein a second formula is utilized for converting the calculated Y value, the U value, and the V value to the new R, G, and B values, the second formula is shown below:
R=Y+1.14V;
G=Y−0.39U−0.58V;
B=Y+2.03U.

10. An image processing method comprising the steps of:
receiving a plurality of single color image signals from an image sensor, and delaying the received single color image signals belonging to a plurality of pixels for storing in a delay unit;
retrieving the single color image signals from the delay unit simultaneously, and determining original red (R), green (G), and blue (B) values for each of the two neighboring pixels of the image sensor with respect to the retrieved single color image signals using an interpolation algorithm;
converting the original R, G, and B values for each of the two neighboring pixels to luminance (Y), chrominance (U), and chroma (V) values;
calculating an average Y value of two Y values for the two neighboring pixels and keeping the U value, and the V value unchanged for the two neighboring pixels; and
converting the calculated Y value, the U value, and the V value to new R, G, and B values.

11. The image processing method of claim 10, wherein the action of delaying further comprises:
storing the single color image signals belonging to all pixels arranged in a first row by a storage unit;
delaying the single color image signals directly outputted from the storage unit by a plurality of first registers; and
delaying the single color image signals belonging to multiple pixels arranged in a second row neighboring the first row by a plurality of second registers.

12. The image processing method of claim 11, wherein the action of retrieving further comprises:
retrieving the single color image signals from the first registers, the second registers, and the storage unit simultaneously.

13. The image processing method of claim 12, wherein the action of determining further comprises:
determining the original R, G, and B values for each of the two neighboring pixels of the image sensor with respect to the retrieved single color image signals belonging to eight neighboring pixels using an interpolation algorithm.

14. The image processing method of claim 10, wherein the action of delaying further comprises:
delaying the single color image signals belonging to multiple pixels arranged in a first row by a plurality of first registers, the first registers connected in series with the output terminal of the image sensor; and
delaying the single color image signals belonging to multiple pixels arranged in a second row neighboring the first row by a plurality of second registers, the second registers connected in series with the output terminal of the image sensor.

15. The image processing method of claim 14, wherein the action of retrieving further comprises:
retrieving the single color image signals from the first registers and the second registers simultaneously.

16. The image processing method of claim 15, wherein the action of determining further comprises:
determining the original R, G, and B values for each of the two neighboring pixels of the image sensor with respect to the retrieved single color image signals belonging to eight neighboring pixels using an interpolation algorithm.

17. The image processing method of claim 10, wherein a first formula is utilized for converting the original R, G, and B values to the Y, U, and V values, the first formula is shown below:
Y=0.299R+0.587G+0.114B;
U=−0.147R−0.289G+0.436B;
V=0.615R−0.515G−0.100B.

18. The image processing method of claim 10, wherein a second formula is utilized for converting the calculated Y value, the U value, and the V value to the new R, G, and B values, the second formula is shown below:
R=Y+1.14V;
G=Y−0.39U−0.58V;
B=Y+2.03U.
